(19) United States
(12) Patent Application Publication
(10) Pub. No.: US 2021/0131475 A1
(43) Pub. Date: May 6, 2021

(54) Eccentric threaded fastener with frictional surfaces

(71) Applicant: Yu-Ju Lin, Kaohsiung (TW)

(72) Inventor: Yu-Ju Lin, Kaohsiung (TW)

(21) Appl. No.: 17/148,595

(22) Filed: Jan. 14, 2021

(51) Int. Cl. F16B 33/02

(52) U.S. Cl. CPC F16B 33/02

(57) ABSTRACT

An eccentric threaded fastener includes a bolt; and a fastening mechanism. The bolt includes a head and a threaded shank, the head including a plurality of positioning protrusions formed on a bottom. The fastening mechanism includes two opposite nuts disposed symmetrically along the threaded shank, the nut including a threaded hole for fitting around and securing to the threaded shank, and a frictional surface spirally extending out of one end of the threaded hole, the frictional surface and the threaded hole being co-axial. One end of threads of the threaded hole come into contact with an inner edge of the frictional surface. The frictional surface of one nut come into contact with that of the other nut to form the fastening mechanism with a gap formed between the nuts. A positioning pin is inserted into the gap to lock the nuts.

### BACKGROUND OF THE INVENTION

### 1. Field of the Invention

The invention relates to threaded fasteners and more particularly to an eccentric threaded fastener including a fastening mechanism having two opposite nuts in which on nut has a frictional surface come into contact with a frictional surface of the other nut and secured thereto by a positioning pin.

### 2. Description of Related Art

Typically, a workpiece fastened by a screw or bolt and nut combination will not become loose in a static state. However, the workpiece may loosen if the workpiece is in a vibrational environment for a long time because the vibration may be transferred to the screw or bolt and nut combination and loosen the screw or bolt and nut combination.

Thus, the need for improvement still exists.

### SUMMARY OF THE INVENTION

It is therefore one object of the invention to provide an eccentric threaded fastener capable of withstanding a vibrational environment without being loosened.

To achieve above and other objects of the invention, the invention provides an eccentric threaded fastener comprising a bolt; and a fastening mechanism; wherein the bolt includes a head and a threaded shank, the head including a plurality of positioning protrusions formed on a bottom; and wherein the fastening mechanism includes two opposite nuts disposed symmetrically along the threaded shank, the nut including a threaded hole for fitting around and securing to the threaded shank, and a frictional surface spirally extending out of one end of the threaded hole, the frictional surface and the threaded hole being co-axial; one end of threads of the threaded hole come into contact with an inner edge of the frictional surface; and the frictional surface of one nut come into contact with that of the other nut to form the fastening mechanism with a gap formed between the nuts.

Preferably, the positioning protrusions are shaped as a triangular prism and further formed with the threaded shank.

Preferably, the nut further comprises an eccentric surface adjacent to the threaded hole; and wherein the frictional surface spirally extends out of one end of the eccentric surface to the other end thereof.

Preferably, there is further comprised of a positioning pin configured to insert into the gap to lock the nuts.

The above and other objects, features and advantages of the invention will become apparent from the following detailed description taken with the accompanying drawings.

### BRIEF DESCRIPTION OF THE DRAWINGS

FIG. 1 is a perspective view of an eccentric threaded fastener according to a first preferred embodiment of the invention;

FIG. 2 is a perspective view of the bolt;

FIG. 3 is a perspective view of the nut;

FIG. 4 is a side elevation of the nut;

FIG. 5 is a sectional view taken along line A-A of FIG. 3;

FIG. 6 is a longitudinal sectional view of the workpiece having a hole driven through by the bolt in an initial step of installation;

FIG. 7 depicts a longitudinal sectional view of the workpiece and the bolt, and a perspective view of the nut and a wrenching tool which is ready to fasten the workpiece, the bolt and the nut together in a final step of the installation;

FIG. 8 depicts the fastened workpiece, the bolt, the nut and the wrenching tool;

FIG. 9 is a perspective view of FIG. 8;

FIG. 10 is a perspective view of the wrenching tool;

FIG. 11 is a longitudinal section view of the wrench tool;

FIG. 12 is a perspective view of an eccentric threaded fastener according to a second preferred embodiment of the invention;

FIG. 13 is a perspective view of the nut of FIG. 12;

FIG. 14 is a side elevation of the nut of FIG. 13;

FIG. 15 is a sectional view taken along line B-B of FIG. 13;

FIG. 16 is a longitudinal sectional view of the workpiece having a hole driven through by the bolt of FIG. 12 in an initial step of installation;

FIG. 17 depicts a longitudinal sectional view of the workpiece and the bolt, and a perspective view of the nut and a wrenching tool which is ready to fasten the workpiece, the bolt and the nut together in a final step of the installation;

FIG. 18 depicts the fastened workpiece, the bolt, the nut and the wrenching tool of FIG. 17; and

FIG. 19 is a perspective view of FIG. 18.

### DETAILED DESCRIPTION OF THE INVENTION

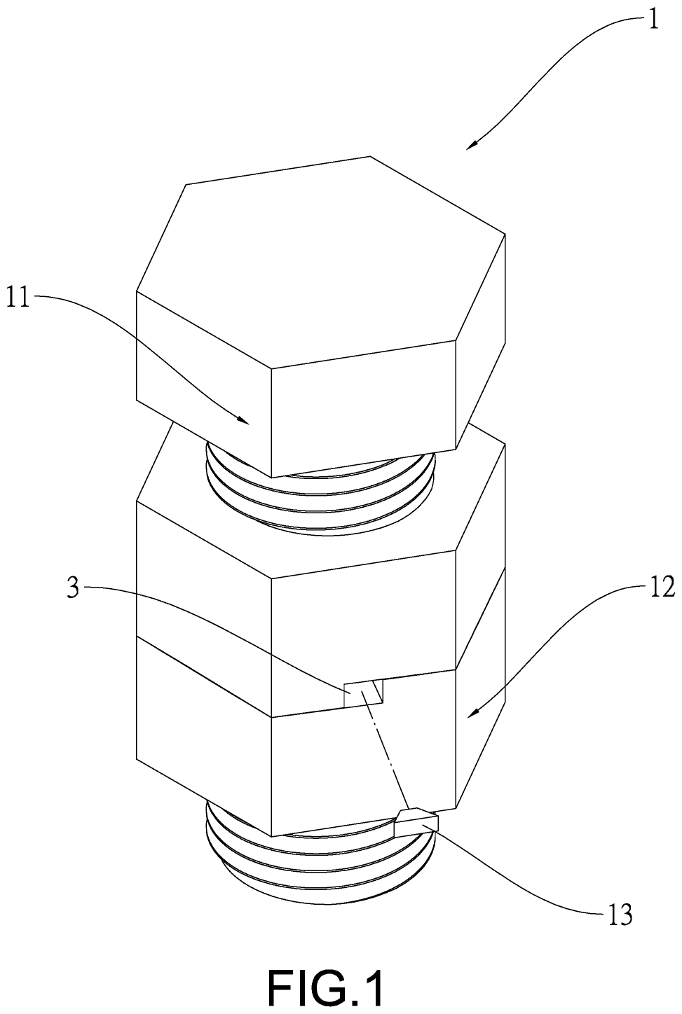

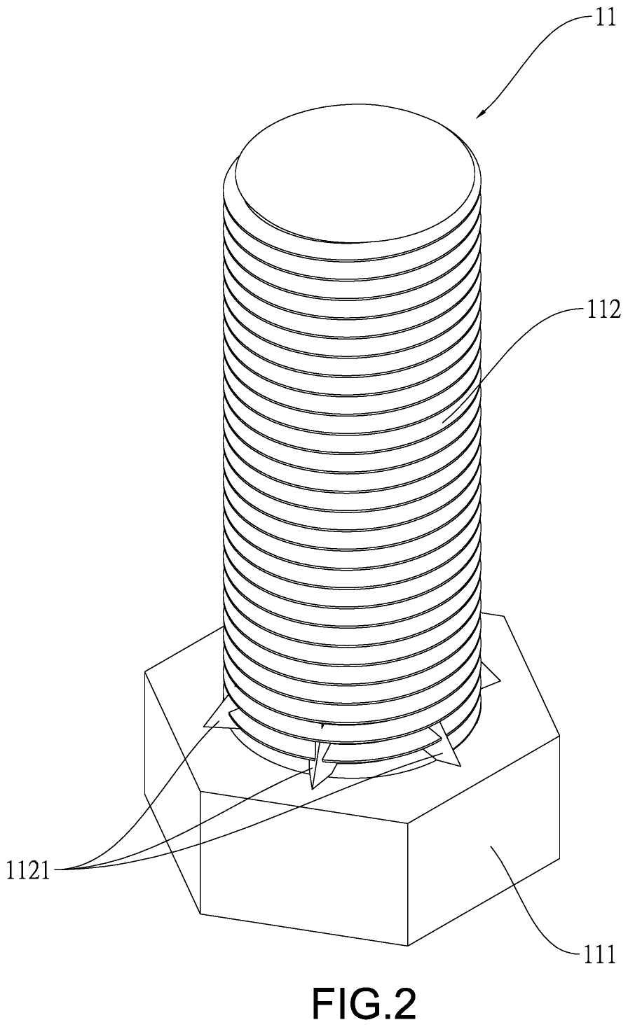

Referring to FIGS. 1 and 2, an eccentric threaded fastener 1 in accordance with a first preferred embodiment of the invention comprises a bolt 11, a fastening mechanism 12 and a positioning pin 13 as discussed below. The bolt 11 includes a head 111 and a threaded shank 112. The head 111 includes a plurality of positioning protrusions 1121 shaped as a triangular prism and formed with the threaded shank 112. A bottom of the positioning protrusion 1121 has a width of 1/30 inch.

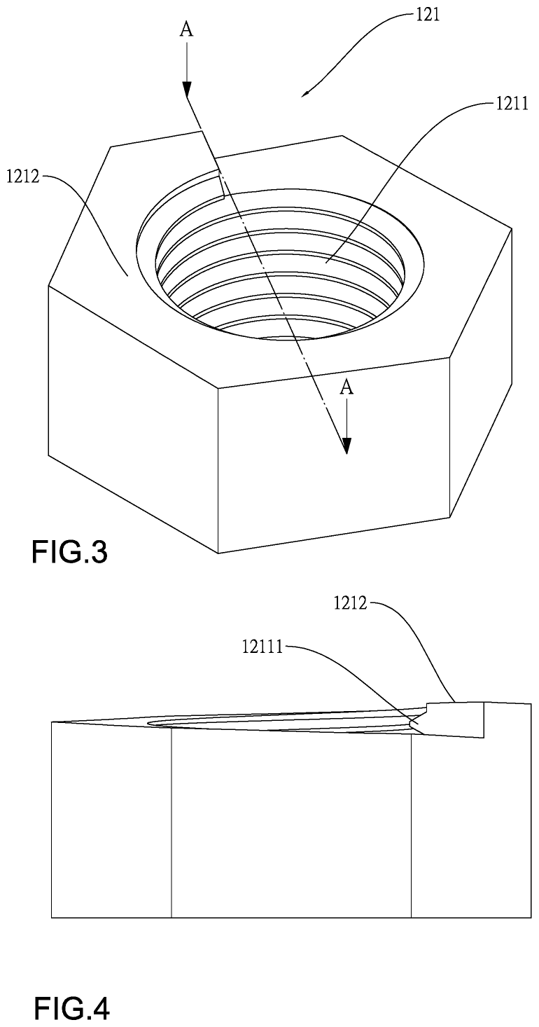

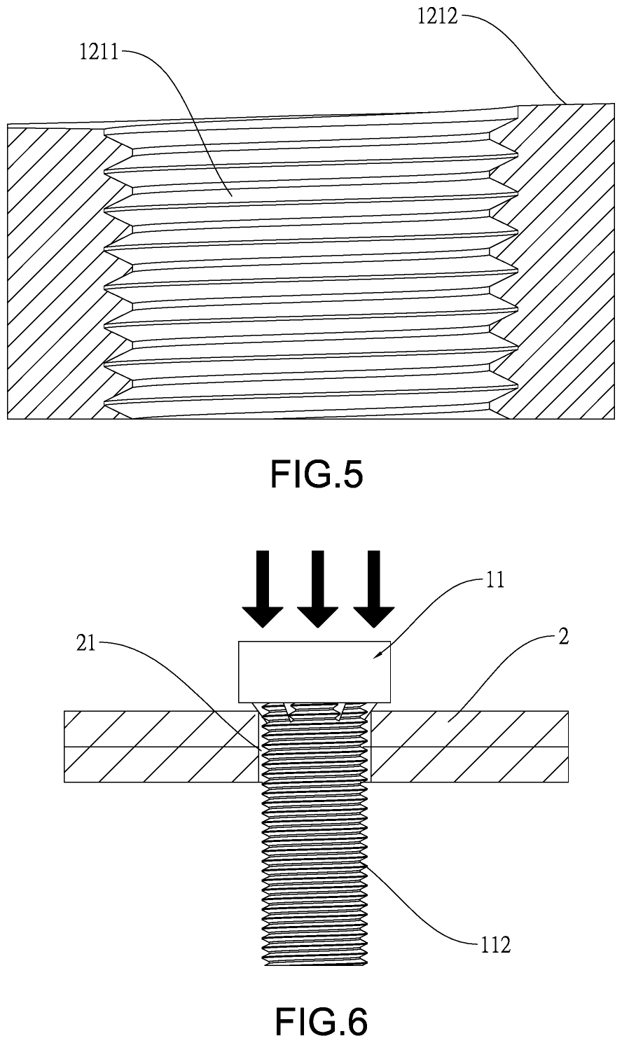

Referring to FIGS. 3, 4 and 5 in conjunction with FIGS. 1 and 2, the fastening mechanism 12 includes two opposite nuts 121 disposed symmetrically along the threaded shank 112. The nut 121 includes a threaded hole 1211 for fitting around and securing to the threaded shank 112 and a frictional surface 1212 spirally extending out of one end of the threaded hole 1211. The spiral frictional surface 1212 and the threaded hole 1211 are co-axial. One end of threads 12111 of the threaded hole 1211 come into contact with an inner edge of the frictional surface 1212. The frictional surface 1212 of one nut 121 may come into contact with that of the other nut 121 to form the fastening mechanism 12 with a gap 3 formed between the nuts 121. The positioning pin 13 is inserted into the gap 3 to lock the nuts 121.

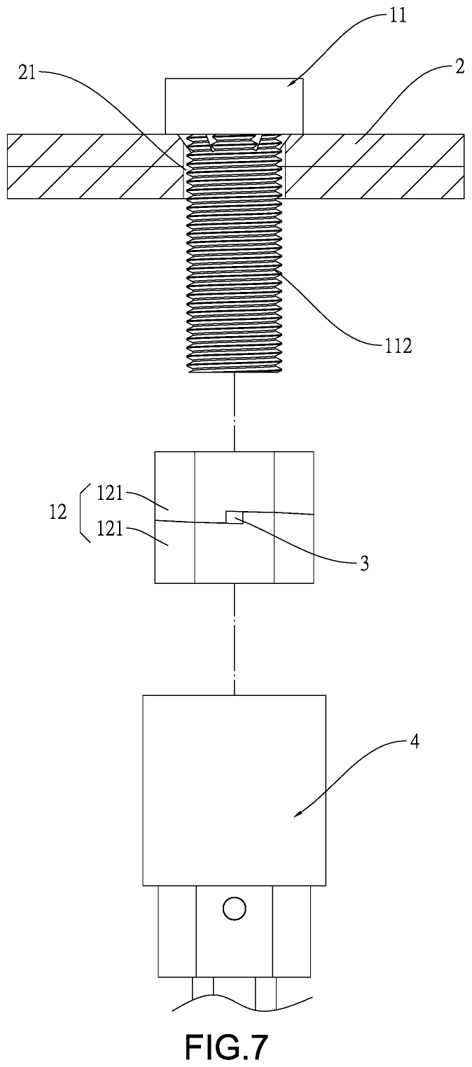

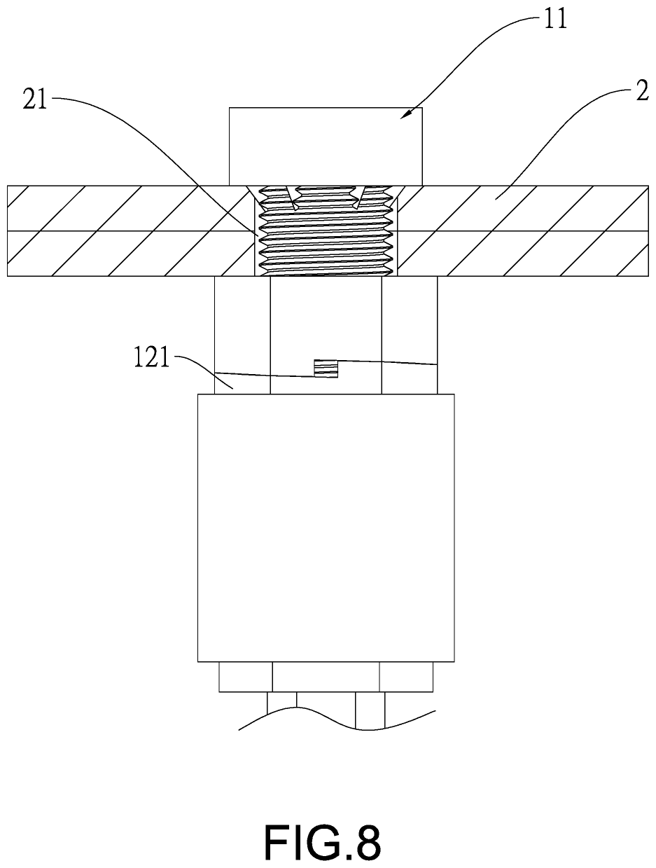

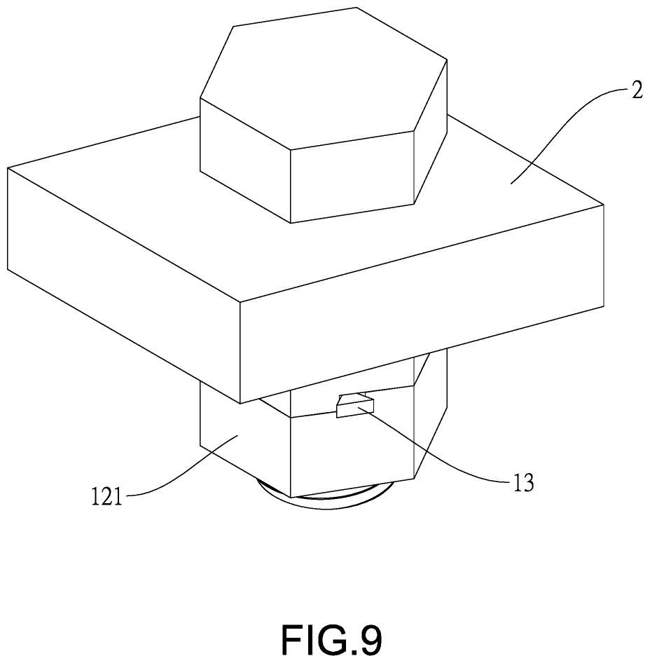

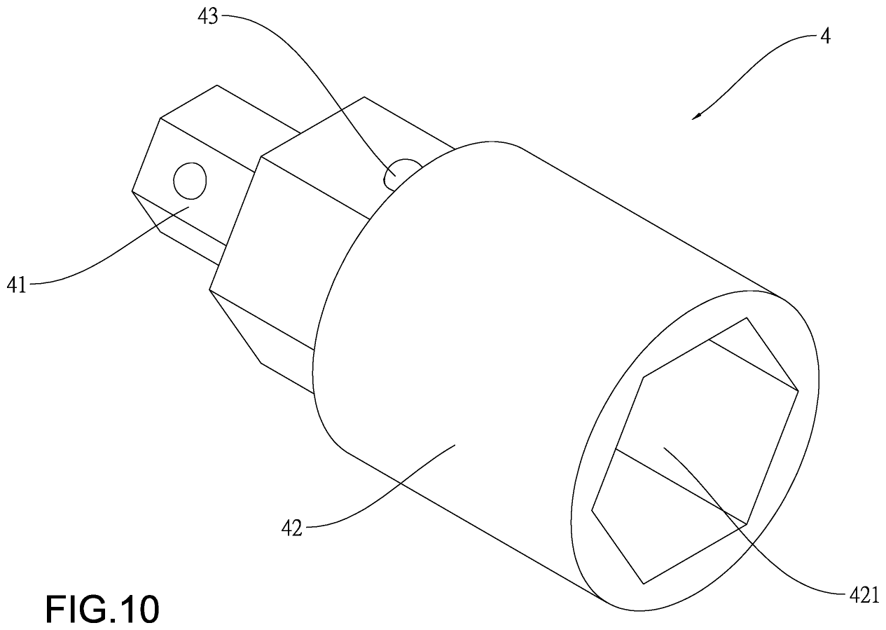

Referring to FIGS. 6 to 9 in conjunction with FIGS. 2 and 3, an installation method of the eccentric threaded fastener 1 of the first preferred embodiment of the invention comprising the steps of: drilling a hole 21 through a workpiece 2, the hole 21 having a bore slightly greater than a diameter of the threaded shank 112 of the bolt 11. Preferably, the bore of the hole 21 is equal to the diameter of the threaded shank 112 plus 1/16 inch; after the bolt 11 has been inserted into the hole 21, a tool is used to hit the head 111 to hammer the positioning protrusions 1121 into a surface of the hole 21. Thus, the bolt 11 is stuck in the hole 21 and fastened therein; stacking the two nuts 121 to form the fastening mechanism 12 with the frictional surface 1212 of one nut 121 come into contact with that of the other nut 121 with a gap 3 formed between them. Next, adhesive is applied to the nuts 121 to hold them in place; using a wrenching tool 4 to hold the nuts 121 onto the threaded shank 112 and driving same to cause a top of one nut 121 to come into contact with a bottom of the workpiece 2; and using the wrenching tool 4 to clockwise rotate the lower nut 121 to increase stress between the frictional surfaces 1212. Further, the frictional surface 1212 of one nut 121 applies a force opposite to a force applied by the frictional surface 1212 of the other nut 121. Next, the positioning pin 13 is hammered into the gap 3 to lock the nuts 121. As a result, the nuts 121 apply a friction to the threaded shank 112 to fasten them together.

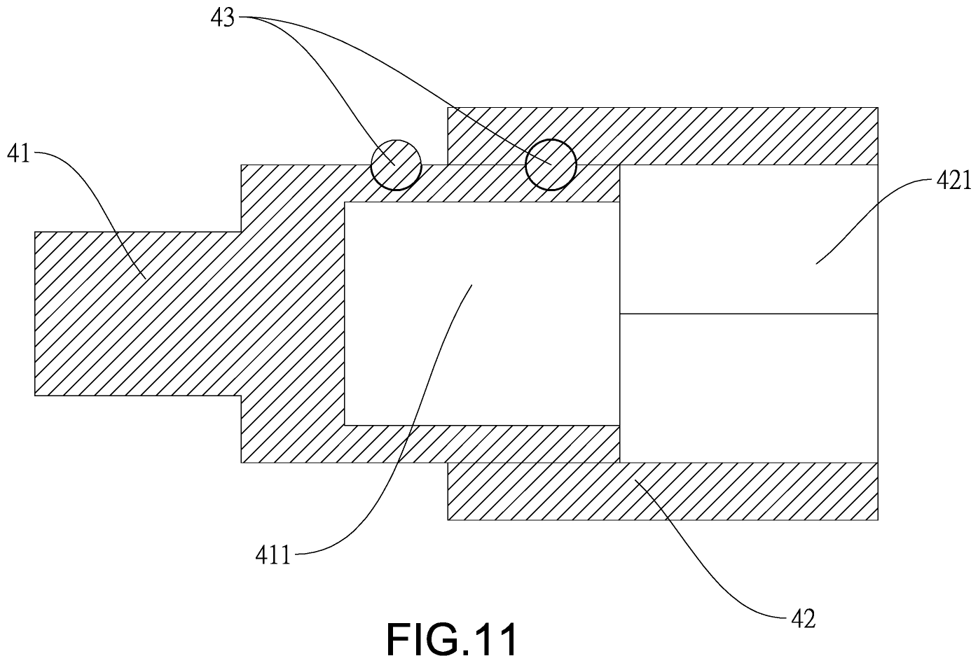

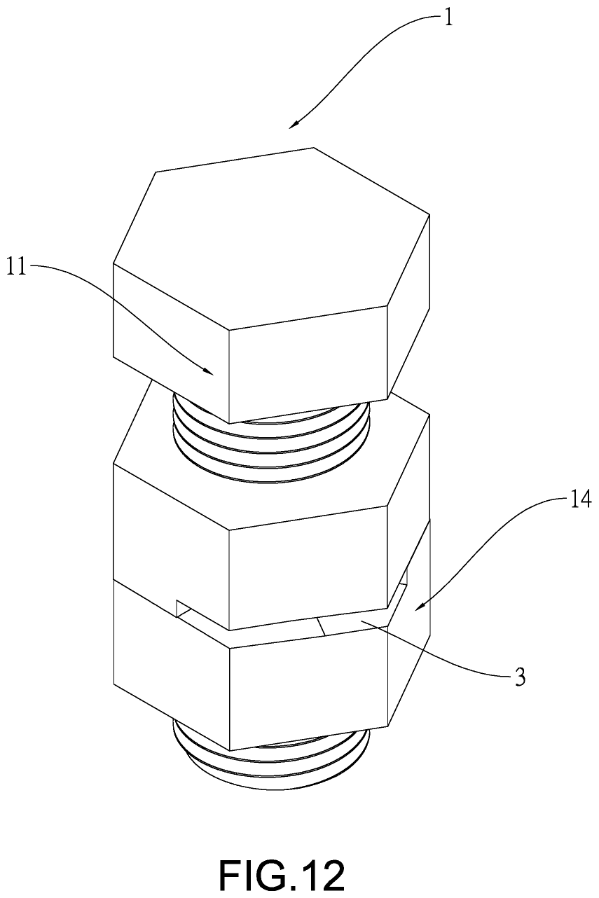

Referring to FIGS. 10 and 11 in conjunction with FIG. 3, the wrenching tool 4 includes a projecting connection part 41 at one end, the connection part 41 adapted to be driven by a portable power tool and having a hole 411, a plurality of positioning balls 43 on the connection part 41, and a sleeve 42 having a socket 421, the sleeve 42 put on a portion of the connection part 41 with the positioning balls 43 positioned between them. The two nuts 121 can be disposed in the socket 421 and the threaded shank 112 may further enter into the hole 411 through the socket 421. In assembly, the wrenching tool 4 pushes the sleeve 42 until the nuts 121 are disposed in the socket 421. Further, in the final fastening step, the sleeve 42 is pulled to leave only one nut 121 in the socket 421.

Referring to FIG. 12 in conjunction with FIG. 2, an eccentric threaded fastener 1 in accordance with a second preferred embodiment of the invention comprises a bolt 11 and a fastening mechanism 12 as discussed below. The bolt 11 includes a head 111 and a threaded shank 112. The head 111 includes a plurality of positioning protrusions 1121 shaped as a triangular prism and formed with the threaded shank 112. A bottom of the positioning protrusion 1121 has a width of 0.85 mm.

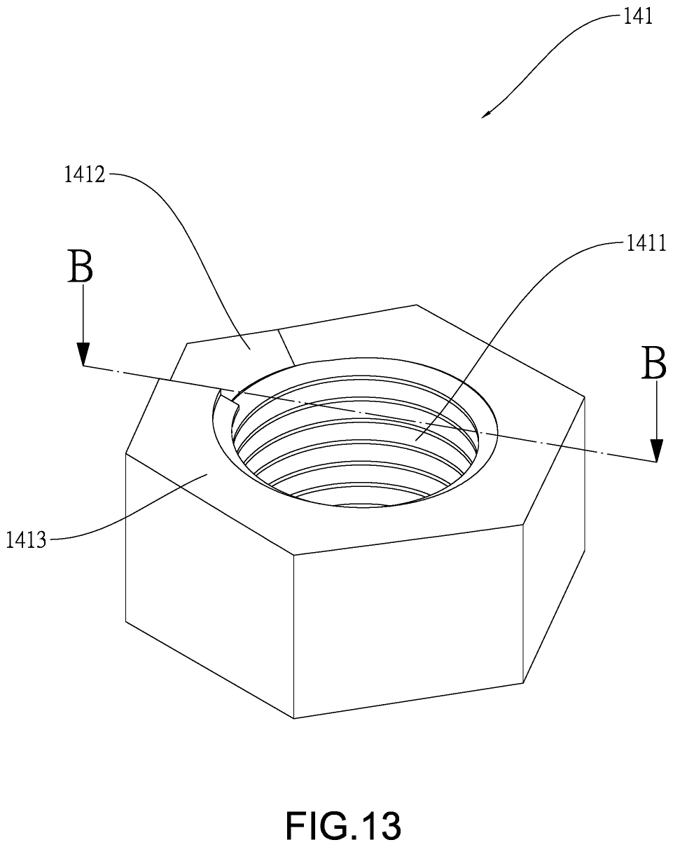

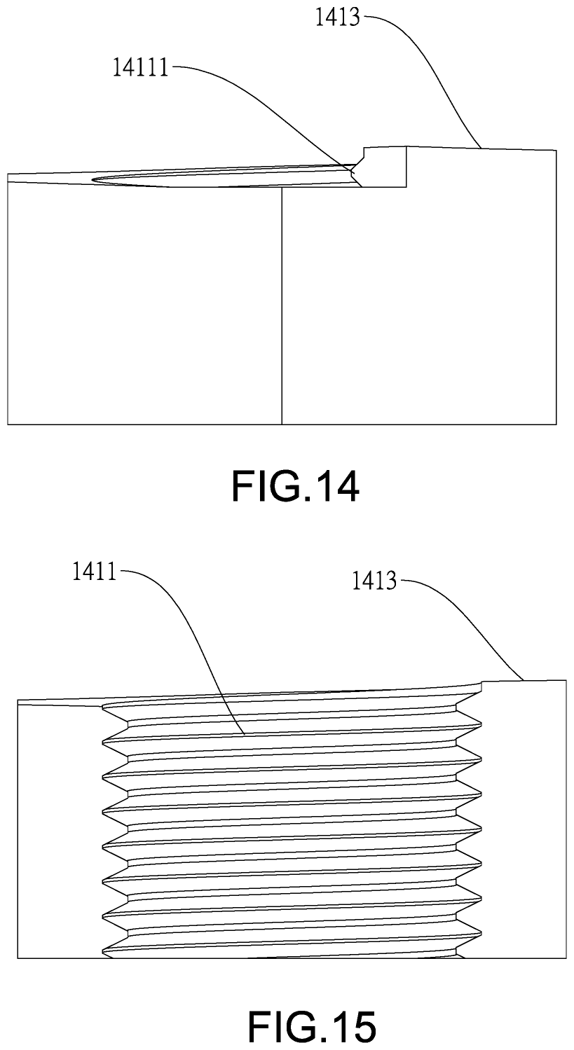

Referring to FIGS. 13 to 15 in conjunction with FIGS. 2 and 12, the fastening mechanism 14 includes two opposite nuts 141 disposed symmetrically along the threaded shank 112. The nut 141 includes a threaded hole 1411 for fitting around and securing to the threaded shank 112, an eccentric surface 1412 adjacent to the threaded hole 1411, and a frictional surface 1413 spirally extending out of one end of the eccentric surface 1412 to the other end thereof. The spiral frictional surface 1413 and the threaded hole 1411 are co-axial. One end of threads 14111 of the threaded hole 1411 come into contact with an inner edge of the frictional surface 1413. The frictional surface 1413 of one nut 141 may come into contact with that of the other nut 141 to form the fastening mechanism 14 with a gap 3 formed between the nuts 141.

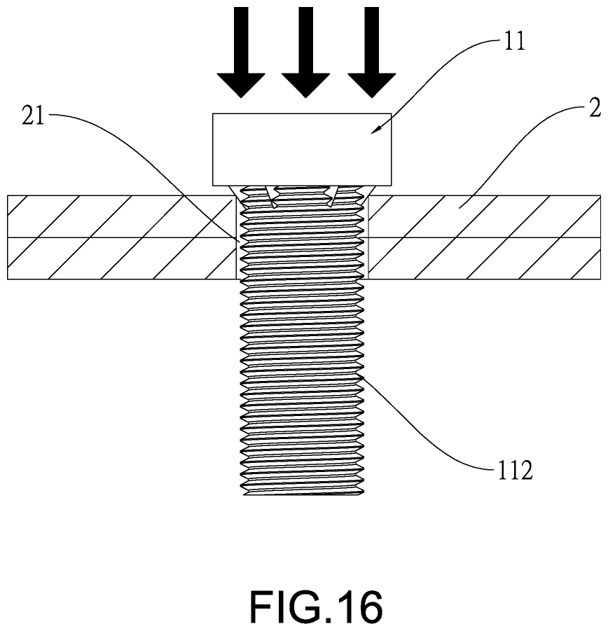

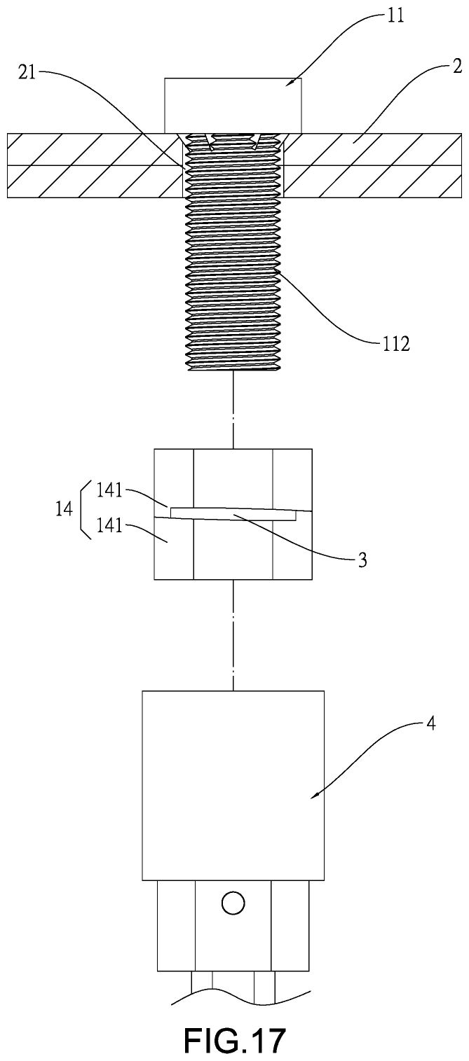

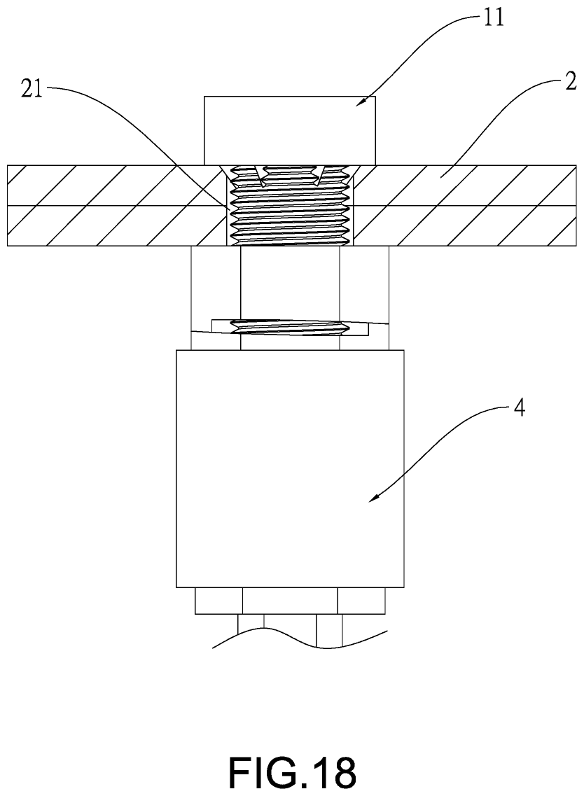

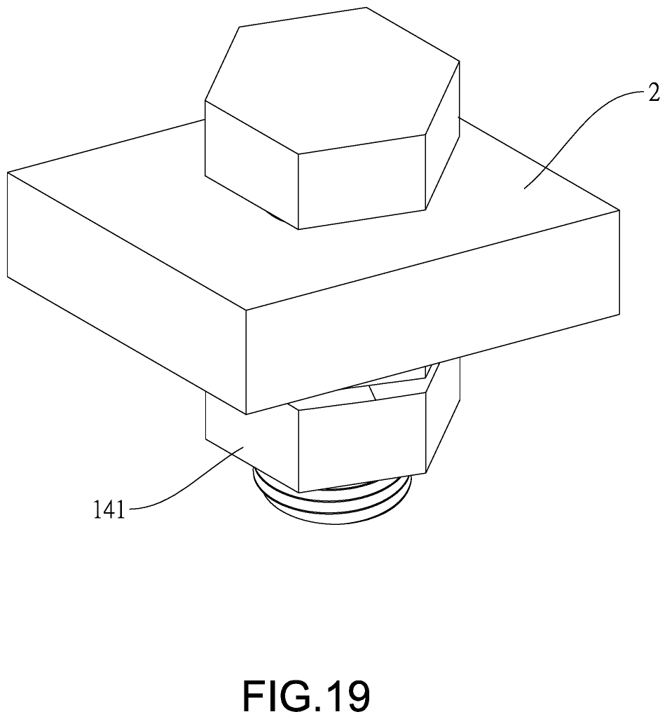

Referring to FIGS. 16 to 19 in conjunction with FIGS. 2 and 13, an installation method of the eccentric threaded fastener 1 of the second preferred embodiment of the invention comprising the steps of: drilling a hole 21 through a workpiece 2, the hole 21 having a bore slightly greater than a diameter of the threaded shank 112 of the bolt 11. Preferably, the bore of the hole 21 is equal to the diameter of the threaded shank 112 plus 1.5 mm; after the bolt 11 has been inserted into the hole 21, a tool is used to hit the head 111 to hammer the positioning protrusions 1121 into a surface of the hole 21. Thus, the bolt 11 is stuck in the hole 21 and fastened therein; stacking the two nuts 141 to form the fastening mechanism 14 with the frictional surface 1413 of one nut 141 come into contact with that of the other nut 141 with a gap 3 formed between them. Next, adhesive is applied to the nuts 141 to hold them in place; using a wrenching tool 4 to hold the nuts 141 onto the threaded shank 112 and driving same to cause a top of one nut 141 to come into contact with a bottom of the workpiece 2; and using the wrenching tool 4 to clockwise rotate the lower nut 141 to increase stress between the frictional surfaces 1413. Further, the frictional surface 1413 of one nut 141 applies a force opposite to a force applied by the frictional surface 1413 of the other nut 141. Thus, an eccentric force of the nuts 141 is generated and the nuts 141 apply a friction to the threaded shank 112 to fasten them together.

Referring to FIGS. 10 and 11 again in conjunction with FIG. 13, the wrenching tool 4 includes a projecting connection part 41 at one end, the connection part 41 adapted to be driven by a portable power tool and having a hole 411, a plurality of positioning balls 43 on the connection part 41, and a sleeve 42 having a socket 421, the sleeve 42 put on a portion of the connection part 41 with the positioning balls 43 positioned between them. The two nuts 121 can be disposed in the socket 421 and the threaded shank 112 may further enter into the hole 411 through the socket 421. In assembly, the wrenching tool 4 pushes the sleeve 42 until the nuts 121 are disposed in the socket 421. Further, in the final fastening step, the sleeve 42 is pulled to leave only one nut 121 in the socket 421.

While the invention has been described in terms of preferred embodiments, those skilled in the art will recognize that the invention can be practiced with modifications within the spirit and scope of the appended claims.

What is claimed is:

1. An eccentric threaded fastener comprising:
a bolt; and
a fastening mechanism;
wherein the bolt includes a head and a threaded shank, the head including a plurality of positioning protrusions formed on a bottom; and
wherein the fastening mechanism includes two opposite nuts disposed symmetrically along the threaded shank, the nut including a threaded hole for fitting around and securing to the threaded shank, and a frictional surface spirally extending out of one end of the threaded hole, the frictional surface and the threaded hole being co-axial; one end of threads of the threaded hole come into contact with an inner edge of the frictional surface; and the frictional surface of one nut come into contact with that of the other nut to form the fastening mechanism with a gap formed between the nuts.

2. The eccentric threaded fastener of claim 1, wherein the positioning protrusions are shaped as a triangular prism and further formed with the threaded shank.

3. The eccentric threaded fastener of claim 1, wherein the nut further comprises an eccentric surface adjacent to the threaded hole; and wherein the frictional surface spirally extends out of one end of the eccentric surface to the other end thereof.

4. The eccentric threaded fastener of claim 1, further comprising a positioning pin configured to insert into the gap to lock the nuts.
